(19) United States
(12) Patent Application Publication
(10) Pub. No.: US 2012/0317972 A1
(43) Pub. Date: Dec. 20, 2012

(54) Two cycles heat engine

(76) Inventor: Harold Lee Carder, Fleming Island, FL (US)

(21) Appl. No.: 13/065,938

(22) Filed: Apr. 2, 2011

Related U.S. Application Data
(60) Provisional application No. 61/341,840, filed on Apr. 5, 2010.

(51) Int. Cl. F02G 1/043

(52) U.S. Cl. 60/523; 60/517

(57) ABSTRACT

A thermal engine with a heated external chamber capable of generating highly compressed fluid, releasing work energy when injected into a cylinder of an engine equipped with a one cycle cam shaft, thus producing power on every one half revolution of the crank shaft. The exhaust stroke is utilized to pressurize the fluid in the system by forcing the spent fluid into a manifold, pressurized fluid is prevented from returning to the engine by a one way gate valve. The fluid is then forced into a pre-cooler tank through an adjustable one way valve then into a cooling tank through a one way valve where it cooled and pressurized and returned to the expansion chamber through a one way valve and the process is repeated. The engine speed is controlled by a bypass system connecting the expansion chamber and the manifold.

This application claims the benefit of provisional application 61/341,840 filed Apr. 5, 2010

### RESEARCH

| | |
|---|---|
| Current US Class | 60/516, 60/670, 60/524, 123/2 |
| International class | F02K123/06, 20060101, F01K023/06 |

### REFERENCES

U.S. patent Documents

| | | |
|---|---|---|
| 20110005472 | Jan. 13, 2011 | Larson, Martin |
| 20100275591 | Nov. 4, 2010 | John Hammerman Jr. |
| 20100257858 | Oct. 14 2010 | Hiroshi Yaguchi |
| 7,681,397 | Mar., 23, 2010 | ASSAF |
| 7,677,039 | Mar. 16, 2010 | Fleck |
| 7,387,093 | Jun. 17, 2008 | HACS 11 |
| 7,121,236 | Oct. 17, 2006 | Scuderi, etal |
| 3,552,120 | Jan. 5, 1971 | William T. Beal |
| 3,548,589 | Dec. 22, 1970 | E. H. Cooke-Yarboro |

Foreign Patent Documents

| | | |
|---|---|---|
| 20020029567 | Mar. 14, 2002 | Kamen, Dean, eta |
| 20050000213 | Jan. 6, 2005 | Carmeron, Kischael |

### DISCOVERY

The Sterling Engine was discovered over a century ago, but fell out of favor due to the steam engine. This design has received little attention until the oil shortage renewed interest. The design had many problems: lack of horse power, engine control, and lack of a portable heat source. Many solutions have been proposed with varying degrees of success but no real solutions or innovations have resulted. All proposals involved a two cycle system using a second cylinder and piston to complete the process. To improve the system which is low compression by nature, a new system had to be found. The solution proposed by this device addresses those problems in a new direction and solves them.

### FIELD OF INVESTIGATION

This investigation is related to heat engines, particularly those concerned with heat engines operating on the Sterling Cycle. The purpose is to produce a dependable, economical means of supplying energy for transportation, generating electricity, reducing pollution and reducing dependency on oil or other fossil fuels.

### PRIOR ARTS

Many variations and applications of the Sterling Cycle Engine were discovered and proposed. The engine described would seem preferable to the one proposed by John Hammerman Jr., US Patent 20100275591, in which he describes an application incorporating burning wood pellets, which would produce pollution and require a supply of wood pellets to operate. The application proposed by Larson Martin, US Patent 20110005472, operates on cryogenic temperatures of liquid nitrogen. This would present a problem in maintaining a supply of liquid nitrogen as well as the skill required to handle the temperatures of such a fuel. Many other applications were discovered such as those presented by Ford Motor Co. by burning a fuel in a parallel cylinder and using the energy generated to power a second cylinder by bridging the two cylinders; this still produces pollution and does not reduce the use of fossil fuels. I, therefore, believe this application is unique as its fuel is self generating, nothing is consumed, and no pollution is generated.

### DESCRIPTION OF DRAWINGS

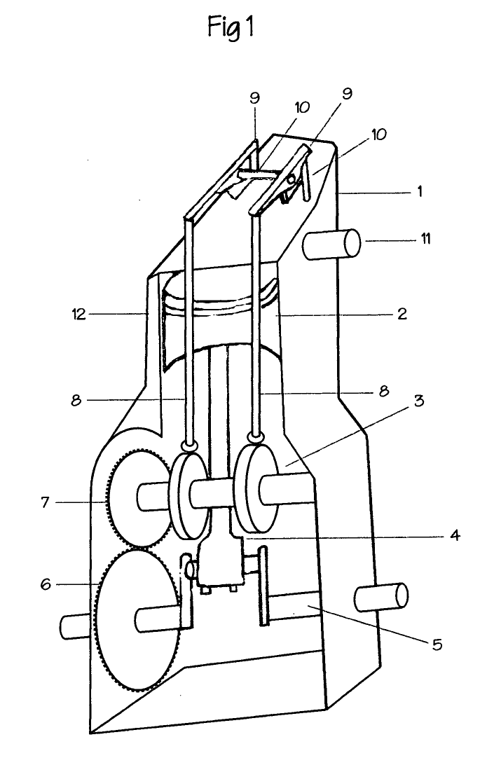

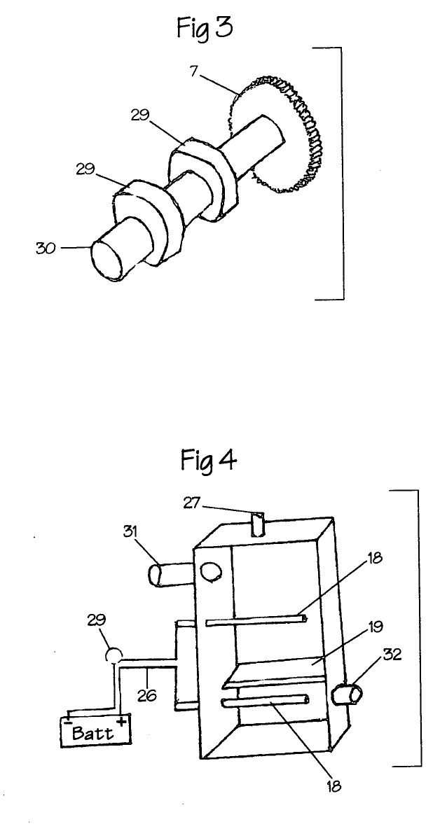

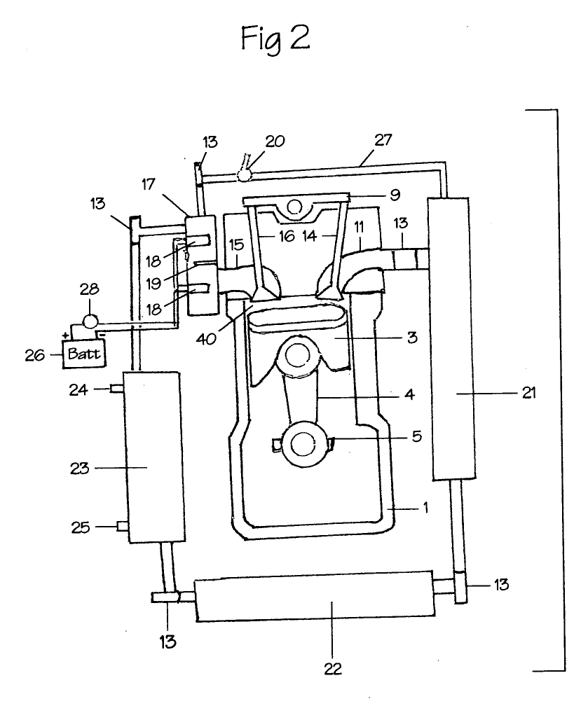

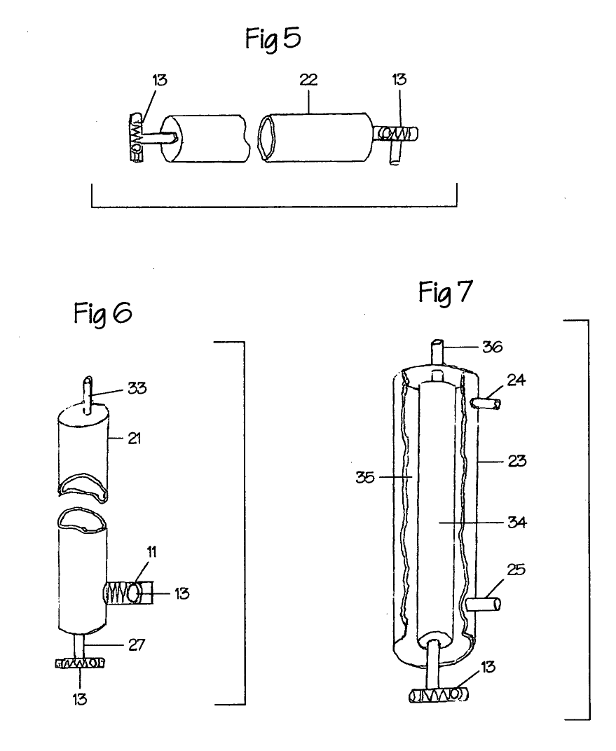

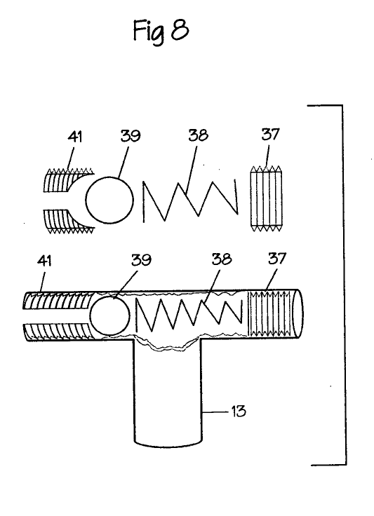

A single cycle engine is made using a standard “off the shelf” four-cycle engine, removing the fuel and exhaust systems and electrical equipment. A Single Cycle Cam (FIG. 1, Part 3) (FIG. 2, Part 3) replaces the original cam, thus converting the four cycle engine into a single cycle engine. Thus one half revolution of the Crank Shaft (FIG. 1, part 5) (FIG. 2, Part 5) Is divided into a power stroke and exhaust stroke, which is utilized for compressing spent fluid and returning the fluid under pressure to be used again. This eliminates any need for a system to move the fluid using the Sterling Cycle and improves efficiency (FIG. 2, Page 2). Useful energy is produced when compressed, heated air is released from the External Expansion Chamber (FIG. 2, Part 17) (FIG. 4, Part 17) by opening Intake Valve (FIG. 2, Part 16) to Cylinder (FIG. 2, Part 40) forcing Piston (FIG. 1, Part 2) down. Power is increased by delaying Intake Valve (FIG. 2, Part 16) until Piston (FIG. 1, Part 2) is 5 to 10 degrees after top dead center. This is a more favorable position than top dead center. Additional power is achieved from the external Expansion Chamber (FIG. 2, Part 17) (FIG. 4, Part 17) by delaying closing of Intake Valve (FIG. 2, Part 16) until Piston (FIG. 1, Part 2) reaches 80% completion of power stroke. The Crank Shaft (FIG. 1, Part 5) (FIG. 2, Part 5) Is then rotated by centrifugal force to place the Piston (FIG. 1, Part 2) in the exhaust position. Cylinder Exhaust Valve (FIG. 2, Part 14) is opened exhausting pressurized hot fluid to Manifold (FIG. 2, Part 21) (FIG. 6, Part 21). Exhaust Valve (FIG. 2, Part 14) remains open until Piston (FIG. 1, Part 2) is at top dead center, removing any remaining fluid. Pressure back flows from the Manifold (FIG. 2, Part 21) (FIG. 6, Part 21) to the Cylinder (FIG. 2, Part 40) by Gate Valve (FIG. 2, Part 13) (FIG. 5, Part 13) (FIG. 6, Part 13) (FIG. 7 Part 13) (FIG. 8, Part 13) thus decreasing energy required from piston (FIG. 1, Part 2) to complete the exhaust and compression strokes and maintain pressure in the system. The fluid is then moved from the Manifold (FIG. 2, Part 21) (FIG. 6, Part 21) via Gate Valve (FIG. 2, Part 13) (FIG. 5, Part 13) (FIG. 6, Part 13) (FIG. 7, Part 13) (FIG. 8, Part 13) to the Pre-Cooler Tank (FIG. 2, Part 22) (FIG. 2, Part 22) where fluid is cooled and exits through Gate Valve (FIG. 2, Part 13) (FIG. 5, Part 13) (FIG. 6, Part 13) (FIG. 7, Part 13) (FIG. 8, Part 13) to the Cooling Tank (FIG. 2, Part 23) (FIG. 7, Part 23) which is encased in a water cooling jacket, part of the Cooling Tank (FIG. 7 Part 23). Fluid is then cooled to ambient temperature or below and pressurized by the action of the exhaust stroke of the Piston (FIG. 1, Part 2). The cooled, pressurized fluid is then injected under high pressure into the Expansion Chamber (FIG. 2, Part 17) (FIG. 4, Part 17) and prevented from flowing back into the system by a Gate Valve (FIG. 2, Part 13) (FIG. 5, Part 13) (FIG. 6, Part 13) (FIG. 7, Part 13) (FIG. 8, Part 13). The Fluid is then subjected to very high heat by Electric Heaters (FIG. 2, Part 18) (FIG. 4, Part 18) in the Expansion Chamber (FIG. 2, Part 17) (FIG. 4, Part 17) where it expands to a very high pressure and is then injected to the Cylinder (FIG. 2, Part 40) though the Intake Port (FIG. 2, Part 15) and controlled by the Intake Valve (FIG. 2, Part 16). The Expansion Chamber (FIG. 2, Part 17) (FIG. 4, Part 17) is equipped with numerous Electric Heaters (FIG. 2, Part 18) (FIG. 4, Part 18) which are powered by Electric Source (FIG. 2, Part 26) (FIG. 4, part 26). This can be either battery or generated power. The Expansion Chamber (FIG. 2, Part 17) (FIG. 4, Part 17) has a Baffle (FIG. 2, Part 19) (FIG. 4, Part 19) which insures even heating and expansion of working fluid. A by-pass system is installed between the Expansion Chamber (FIG. 2, Part 17) (FIG. 4, Part 17) and the Manifold (FIG. 2, Part 21) (FIG. 6, Part 21). The By-Pass Line (FIG. 2, Part 27) (FIG. 6, Part 27) contains a Gate Valve (FIG. 2, Part 13) (FIG. 5, Part 13) (FIG. 6, Part 13) (FIG. 7, Part 13) (FIG. 8, Part 13) to prevent fluid back flow, and a By-Pass Valve (FIG. 2, Part 20) which can be opened to slow the engine or to relieve over pressure in the system.

PARTS LIST

| PART | | FIGURE | |
|---|---|---|---|
| NUMBER | DESCRIPTION | NUMBER | PAGE |
| 1. | ENGINE BLOCK | 1 | 1 |
| 2. | PISTON | 1 | 1 |
| 3. | SINGLE CYCLE CAM | 1, 2 | 1, 3 |
| 4. | CONNECTING ROD | 1, 2 | 1, 2 |
| 5. | CRANK SHAFT | 1, 2 | 1, 2 |
| 6. | CAM DRIVE GEAR | 1 | 1 |
| 7. | CAM SHAFT TIMING GEAR | 1, 3 | 1, 3 |
| 8. | VALVE PUSH ROD | 1, 2 | 1, 2 |
| 9. | VALVE ROCKER ARM | 1, 2 | 1, 2 |
| 10. | VALVE STEM | 1, 2 | 1, 2 |
| 11. | EXHAUST PORT | 1, 2 | 1, 2 |
| 12. | PISTON RINGS | 1, 2 | 1, 2 |
| 13. | GATE VALVE | 2, 5, 6, 7, 8 | 2, 4, 5 |
| 14. | EXHAUST VALVE | 2 | 2 |
| 15. | INTAKE PORT | 2 | 2 |
| 16. | INTAKE VALVE | 2 | 2 |
| 17. | EXPANSION CHAMBER | 2, 4 | 2, 3 |
| 18. | ELECTRIC HEATERS | 2, 4 | 2, 3 |
| 19. | BAFFEL | 2, 4 | 2, 3 |
| 20. | BY-PASS VALVE | 2 | 2 |
| 21. | MANIFOLD | 2, 6 | 2, 4 |
| 22. | PRE-COOLER | 2, 5 | 2, 4 |
| 23. | COOLING TANK | 2, 7 | 2, 4 |
| 24. | COOLANT INLET | 2, 7 | 2, 4 |
| 25. | COOLANT OUTLET | 2, 7 | 2, 4 |
| 26. | ELECTRIC SOURCE | 2, 4 | 2, 3 |
| 27. | EXPANSION CHAMBER BY-PASS | 2, 6 | 2, 4 |
| | LINE | | |
| 28. | RHEOSTAT (NO DESCRIPTION) | 4 | 3 |
| 29. | DOUBLE LOBES | 1, 3 | 1, 3 |
| 30. | CAM SHAFT | 1, 3 | 1, 3 |
| 31. | INLET FROM COOLING TANK | 2, 4 | 2, 3 |
| 32. | OUTLET TO MOTOR | 2, 4 | 2, 3 |
| 33. | OUTLET TO PRE-COOLER | 2, 6 | 2, 4 |
| 34. | COLD TANK | 2, 7 | 2, 4 |
| 35. | COOLANT | 7 | 4 |
| 36. | OUTLET TO EXPANSION | 7 | 4 |
| | CHAMBER | | |
| 37. | VALVE ADJUSTMENT | 8 | 5 |
| 38. | SPRING | 8 | 5 |
| 39. | BALL | 8 | 5 |
| 40. | CYLINDER | 2 | 2 |
| 41. | VALVE SEAT | 8 | 5 |

1. This engine is a single cycle, hot air sterling engine containing an electrically heated external expansion chamber, single cycle cam, cylinder, piston moving in a reciprocating motion, connected to a crank shaft by a connecting rod converting rotary motion to useful energy using any inert gas as a working fluid.

2. Power is created by injecting cold working fluid under high pressure into a superheated external expansion chamber, comprising of electric heaters and baffles, connected to a by-pass system controlling engine rpm and pressure.

3. A single cycle cam enables the piston to provide power on the first half revolution of the crank shaft and compression to the system on the other half pressurizing manifold regulated by gate valves located throughout the system, pre-cooler and cold tank thus supplying high pressure fluid to the external expansion tank.
